(19) United States
(12) Patent Application Publication
(10) Pub. No.: US 2015/0235256 A1
(43) Pub. Date: Aug. 20, 2015

(54) METHOD AND APPARATUS FOR POINT-OF-SALE PROCESSING OF A LOYALTY TRANSACTION

(71) Applicant: PRESIDENT'S CHOICE BANK, Toronto (CA)

(72) Inventors: Matthew BARSOUM, Richmond Hill (CA); Ovidiu Dorel COZOS, Maple (CA); Thomas Chi Ho WONG, Markham (CA)

(21) Appl. No.: 14/495,152

(22) Filed: Sep. 24, 2014

(30) Foreign Application Priority Data
Feb. 14, 2014 (CA) 2842992
Feb. 27, 2014 (CA) 2844231

(51) Int. Cl. G06Q 30/02; G06Q 20/32; G06Q 20/20; G06Q 20/36

(52) U.S. Cl. CPC G06Q 30/0233; G06Q 20/36; G06Q 20/3278; G06Q 20/202

(57) ABSTRACT

A method and apparatus are provided for point-of-sale processing of a loyalty transaction within a standard financial transaction through a contactless interface, using contactless NFC communications, wherein responsive to a payment and loyalty point earning and redemption command input to a wallet application of a mobile device, the wallet application initiates a loyalty point balance transaction between the mobile device and a loyalty CRM system in response to which the wallet application stores the available points in the mobile device; and wherein responsive to the mobile device being positioned within an RF field of a point-of-sale terminal the wallet application initiates a staged transaction whereby the point-of-sale terminal adjusts a final transaction amount by the available points for redemption.

### FIELD

The present description relates generally to point-of-sale transactions using a contactless device, and more particularly to a method and apparatus for point-of-sale processing of a loyalty transaction within a standard financial transaction through a contactless interface.

### BACKGROUND

A new paradigm is emerging for the payment of merchant goods and services and for administering merchant loyalty programs. Conventionally, a consumer will utilize a plurality of physical credit and/or debit cards to pay for goods and services, and physical loyalty cards, rewards card, points card, etc., which are visually similar to credit and debit cards, for collecting or redeeming loyalty points at a merchant. These physical cards may be carried in a physical wallet, purse or pocket, and are consequently susceptible to accidental loss, theft, etc.

The use of mobile payment services is therefore increasing in popularity as consumers eschew traditional payment methods such as cash, credit and debit cards in favour of electronic accounts held on mobile devices, such as smart phones. Such mobile devices include an integrated circuit (IC) that allow the mobile devices to be used for contactless payment by storing information associated with consumer payment card accounts and for communicating with merchant point-of-sale (POS) terminals. Contactless payment is typically implemented using Near Field Communication (NFC), which is a set of standards for smart phones and similar devices to establish wireless communication with each other by touching them together or bringing them into proximity, usually no more than a few inches.

In a typical mobile payment scenario, a consumer initiates a transaction by visiting a retail store operated by the merchant, selects goods for purchase, and presents the goods to a cashier. The cashier enters transaction data for causing the POS terminal to be readied to accept payment. Then, instead of tapping or swiping a credit or debit card at the POS terminal, the consumer waves or taps his/her NFC-enabled mobile device near/on a proximity reader associated with the POS terminal to initiate the payment transaction, such as deducting payment for a purchase from a debit account or charging payment to a credit card account. The POS terminal then transmits an authorization request that includes the payment card account number and the amount of the transaction to a payment service provider. A series of secure messages are exchanged between the payment service provider, the issuer financial institution that issued the customer's payment card account, a payment system for routing transactions from acquirers to issuers, and an acquirer financial institution that issued the merchant's account, in order to verify, authorize and complete the financial transaction.

In addition to systems for allowing consumers to use mobile devices to complete transactions, systems have been developed to permit collection and redemption of loyalty points and for applying coupon discounts to transactions using mobile devices instead of physical loyalty cards and physical discount coupons. However, the relatively short time period within which to complete a contactless transaction using NFC communications presents challenges to the inclusion of value-added services such as loyalty redemption or coupon discounting simultaneously with mobile payment. For example, US 2013/0046643 (Wall et al.) sets forth a system that uses NFC for an initial secure connection between a mobile device and a POS reader. Keys are exchanged between the mobile device and reader in order to set up a secondary secure communication channel between the mobile device and reader for providing value-added services such as loyalty and coupons. The secondary secure communication channel may use Bluetooth, WiFi or other wireless communication channel suitable for secure persistent communication with the reader from outside of the reader's NFC range of communication.

### SUMMARY

As set forth in greater detail below, a method and apparatus are provided for point-of-sale processing of a loyalty transaction within a standard financial transaction through a contactless interface using contactless NFC communications.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of a block diagram of a system for point-of-sale processing of a loyalty transaction within a standard financial transaction through a contactless interface, using contactless NFC communications, in accordance with an embodiment;

FIG. 2 illustrates a flow chart depicting a method for point-of-sale processing of a loyalty transaction within a standard financial transaction through a contactless interface, using contactless NFC communications, according to the embodiment of FIG. 1;

FIG. 3 illustrates a graphical user interface (GUI) for selecting a payment and a loyalty card using a wallet application on a mobile device in the system of FIG. 1;

FIG. 4 illustrates a graphical user interface (GUI) for initiating a payment transaction using a wallet application on a mobile device in the system of FIG. 1;

FIG. 5 illustrates a flow chart depicting a user interface startup sequence of the method illustrated in FIG. 2; and

FIG. 6 illustrates a flow chart depicting a loyalty transaction sequence of the method illustrated in FIG. 2.

Reference will now be made to the exemplary embodiments illustrated, and specific language will be used herein to describe the same. It will nevertheless be understood that no limitation of the scope of the invention is thereby intended.

### DETAILED DESCRIPTION

It is to be understood that the embodiment set forth herein is not limited to the particular structures or process steps disclosed herein, but is extended to equivalents thereof as would be recognized by those ordinarily skilled in the relevant arts. It should also be understood that terminology employed herein is used for the purpose of describing the particular embodiment only and is not intended to be limiting.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

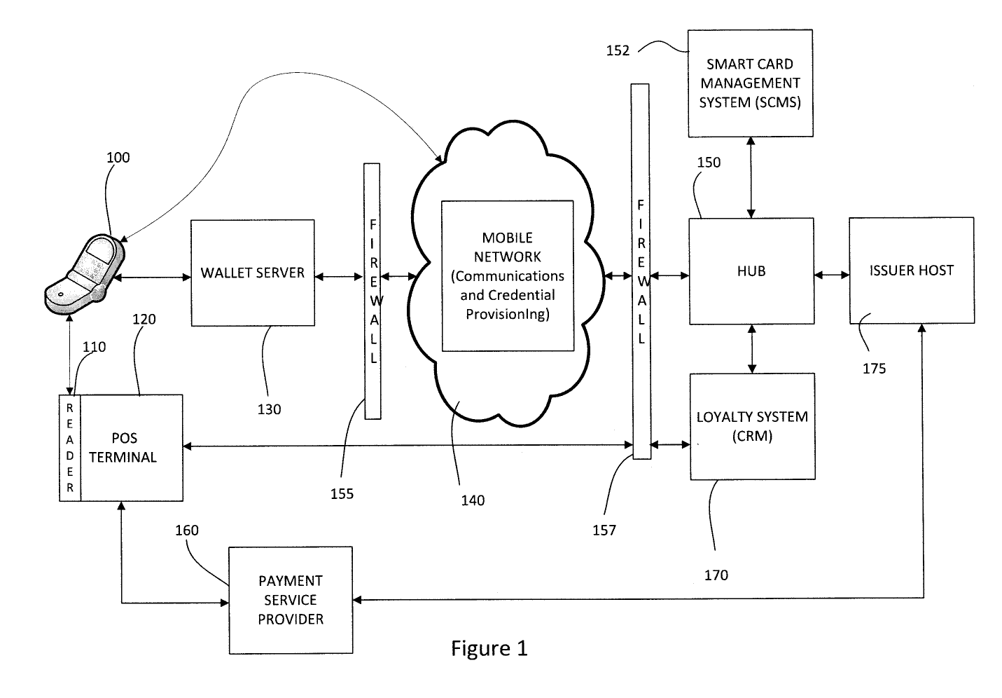

With reference to FIG. 1, a system is illustrated for point-of-sale processing of a loyalty transaction within a standard financial transaction through a contactless interface, using contactless NFC communications, in accordance with an embodiment.

A mobile device 100 may be provided with a software application, referred to herein as a “wallet application”, for storing and managing consumer credit and/or debit account information as well as loyalty information, coupon or discount information and any other account information in a secure container. Mobile device 100 may also be equipped with a secure element (SE). A secure element is a platform onto which account information/credentials and corresponding applications may be added. It consists of hardware, software, interfaces, and protocols that enable the secure storage of service account information and applications, which may be used for the execution of transactions. It will be understood that a SE may be implemented in different form factors such as a Universal Integrated Circuit Card (UICC), an embedded secure element (SE), or NFC enablers such as a separate chip or secure device, which can be inserted into a slot on the mobile device 100. Typically a UICC is in the form of a subscriber identity module (SIM), which is controlled by the mobile network operator (MNO). UICC is used in mobile terminals within GSM and UMTS networks, as defined by ETSI Project Smart Card Platform. An embedded secure element gives service providers the option to embed the SE into the mobile device 100 itself. A SE may include one or more security domains, each of which may be used to separately and securely store data, such as service account information (for example, credit card account numbers, transit accounts, and mobile phone details) and applications, for different service providers. In the case where SE does not exist, the credentials may optionally be stored in a trusted execution environment in the wallet application or another cloud-based secure repository.

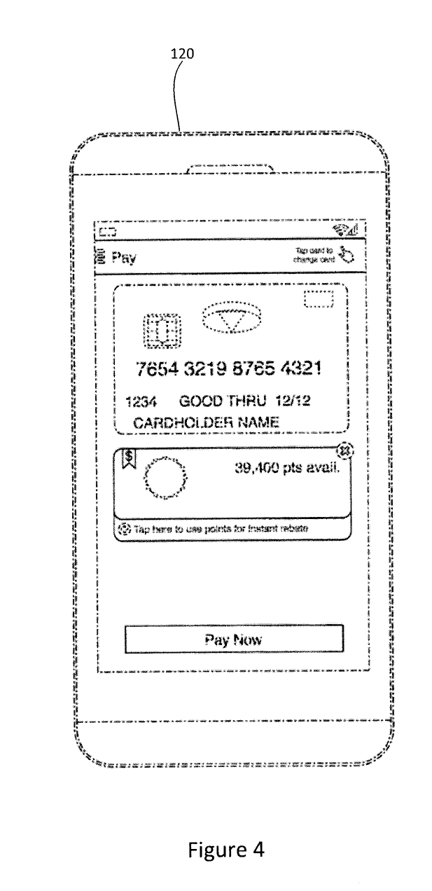

According to one aspect, the SE contains a loyalty applet, payment applet and a Contactless Registry Service (CRS) applet that controls what applets are available in the contactless interface (when the consumer selects the Pay Now button on the mobile device, as discussed in greater detail below with reference to FIG. 4)

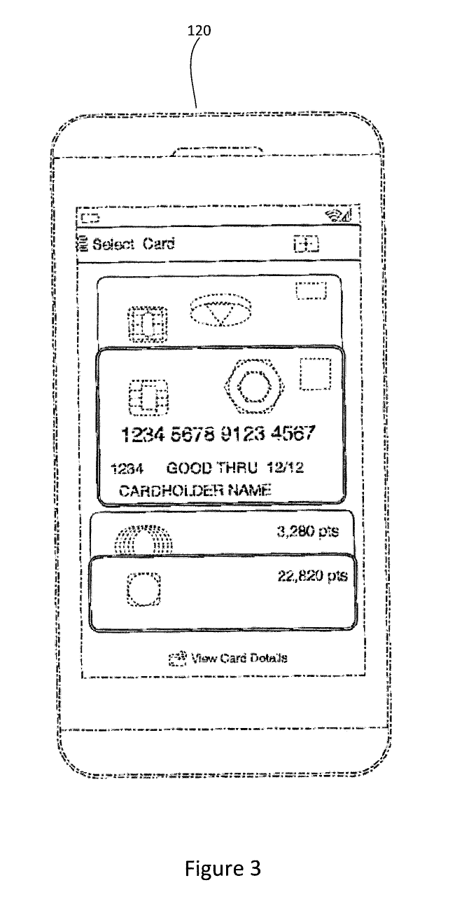

The wallet application running on mobile device 100 includes a GUI (graphical user interface) for interacting with the various payment (e.g. credit/debit) accounts, loyalty programs and coupons, as discussed in greater detail below with reference to FIG. 3 and FIG. 4. In one embodiment, the consumer selects payment and loyalty cards for a transaction (either with or without password/mobile PIN authentication in the secure element), checks loyalty points available from membership in a loyalty program, and indicates an amount of loyalty points to be redeemed against the purchase.

The consumer then positions the mobile device 100 within the RF field of the NFC contactless reader 110. The reader obtains the consumer's payment and loyalty card details from the UICC via NFC, and the POS terminal 120 processes the loyalty point redemption to reduce the total transaction amount to be charged against the selected payment method and processes the transaction using information received from the mobile device 100. More particularly, the POS terminal 120 communicates with a payment service provider 160 (i.e. financial organization) using the same secure process as is used for conventional credit or debit card transactions, and in return the consumer receives an electronic receipt that can be stored in the mobile device 100.

In one embodiment, the consumer downloads the wallet application and manually enters his/her own card details to the application. In another embodiment the consumer taps a contactless card that contain an embedded secure area such as an EMV chip (embedded microprocessor chip that encrypts transaction data) to the mobile device 100, whereupon the payment card account/loyalty numbers are automatically read by the wallet application. The wallet application in the mobile device 100 generates an ‘add mobile credential’ request to a hub 150 (via wallet server 130 and mobile network 140). The hub 150 receives the add mobile credential message and requests the issuer host 175 to generate the mobile card credentials to hub 150 for processing and further enriching by a Smart Card Management System (SCMS) 152. The hub 150 then sends the enriched mobile card credential to the wallet server 130 for provisioning card credentials to the SE (in the mobile device 100 that initiated the ‘add mobile credential request’) via OTA (over the air).

It will be understood by those skilled in the art that the provisioning of payment or other credentials within the SE of the mobile device 100 is typically effected by a trusted service manager (TSM) that has access to the relevant cryptographic keys that permit access to the service provider's secure domain within the SE to provision a payment application and a mobile card credential, or to update a life cycle event of a mobile credential via OTA on behalf of the payment service provider 160. Typically service providers manage the process of equipping mobile device 100 and their SE's with service accounts by performing a number of steps to set up each account on each mobile device, including, for example: collecting and transmitting service account information to each mobile wallet and mobile wallet issuer; ensuring that each mobile device and corresponding MNO is eligible to be equipped with a service account; installing required services and applications to be used with each service account; and adding sensitive payment or other credentials to each SE on each mobile device 100. It will be understood by those skilled in the art that credentials may be provisioned by alternative methods without derogating from the spirit and scope of the invention.

Wallet server 130 receives notifications/requests from either the wallet application installed on mobile device 100 or from a service provider via its TSM. The communication protocol between the mobile device 100 and the wallet server 130 will be via a secure communication technology protocol. The communication protocol between the TSM and the wallet server 130 may, for example, be WebService. In response to receiving a notification/request from the mobile device 100 or TSM, wallet server 130 composes and sends to hub 150 a message which, in an embodiment, is a well formed XML request message. The communication protocol between the wallet server 130 and the hub 150 can, for example, be WebService.

Mobile network 140 provides connection between mobile device 100, wallet server 130, hub 150 and payment service provider 160 (i.e. financial institution). It is intended that mobile network 140 include conventionally understood implementations of cellular connectivity, payment networks, secure domain management, initial and life-cycle provisioning of credentials, and the functionality of the service providers' TSMs described above. All notifications initiated by the mobile device 100 are transmitted by the wallet server 130 to hub 150 for processing. It will be appreciated that the wallet server 130 may be located in any desirable location in the architecture. FIG. 1 shows an embodiment where wallet server 130 and mobile network 140 may be isolated via a first firewall 155, and the mobile network 140 and hub 150 may be isolated via a second firewall 157 in a conventional manner. Alternatively, wallet server 130 may be co-located, for instance, with the hub 150, and isolated from the mobile network 140 by a conventionally understood firewall, and the mobile device 100 may connect to the wallet server 130 via the mobile network 140.

Smart Card management system (SCMS) 152 is a software system that manages smart cards and mobile credentials, for issuing and enriching smart card/mobile credential data and managing the life cycle of smart card/mobile credentials in the SE.

Hub 150 communicates with loyalty system 170 for obtaining loyalty points balance information, as discussed in greater detail below.

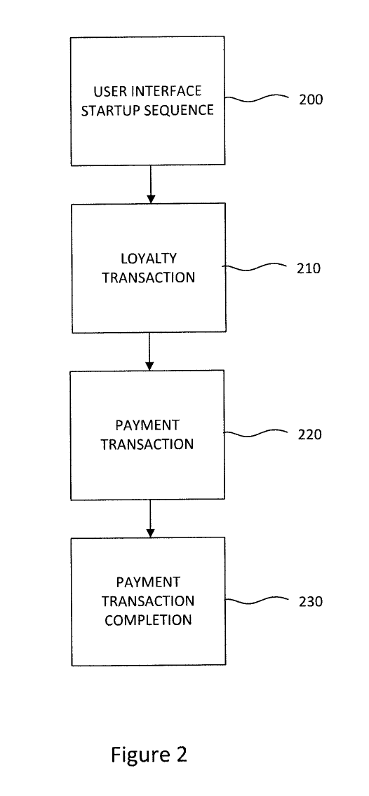

Turning to FIG. 2, a flowchart is illustrated of a method for point-of-sale processing of a loyalty transaction within a standard financial transaction through a contactless interface, using contactless NFC communications, according to the embodiment of FIG. 1.

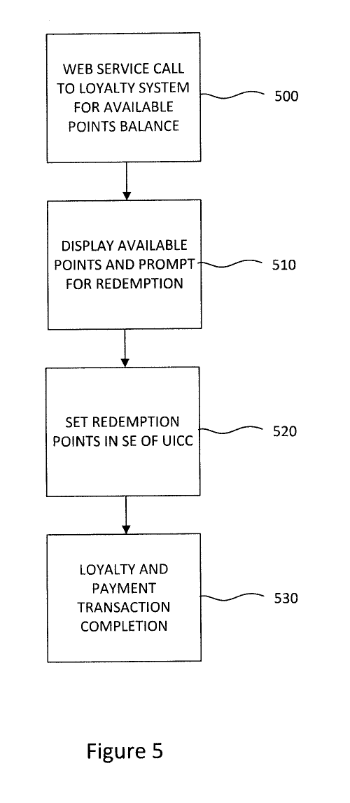

At step 200, upon launching the wallet application, the consumer selects the desired payment card and optionally the loyalty program from a card ‘carousel’ depicted in FIG. 3. As discussed in greater detail below with reference to FIG. 5, a loyalty point balance transaction then occurs between the mobile device 100 and loyalty system (CRM) 170 in response to which the device sets the available loyalty points in the SE. If the consumer wishes to redeem points, then the consumer uses the wallet application GUI to select points for redemption and selects a “Pay Now” button (see FIG. 4).

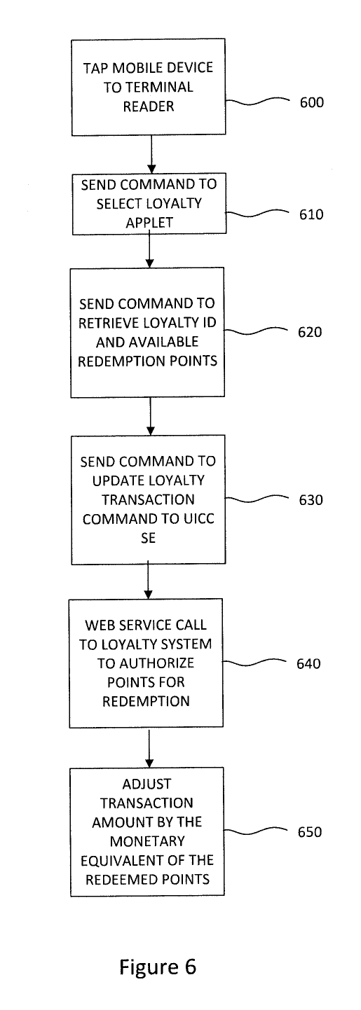

In one embodiment, the merchant cashier enters the transaction amount in POS terminal 120 and, at step 210 the consumer positions mobile device 100 in the RF field of reader 110 in response to which POS terminal 120 initiates a staged transaction, including loyalty points earning, points redemption and payment, resulting in an adjusted transaction amount, as discussed in greater detail below with reference to FIG. 6. This represents a departure from traditional merchandise checkout where the cashier first selects a loyalty transaction and then selects a payment transaction. Therefore, the total transaction time for the consumer at the cashier checkout is reduced when compared to traditional merchandise checkout, as a result of conducting the loyalty point balance transaction prior to payment.

A person of skill in the art will understand that if the consumer is using a self-serve checkout terminal, entry of the transaction amount will be done automatically, for example in response to the consumer passing merchandise under the laser beam of a bar code scanner associated with the self-serve checkout terminal, after which the consumer selects a combined loyalty/payment transaction payment button from the self-serve checkout terminal.

At step 220, upon completion of the loyalty transaction with loyalty system 170, the POS terminal 120 sends commands to the payment applet in the secure element (selected via Proximity Payment Systems Environment (PPSE)) and performs a contactless payment transaction with the adjusted transaction amount. The issuer host 175 also authorizes the payment transaction authorization request (via the payment service provider 160) on behalf of the issuer (e.g. financial institution) when the consumer positions the mobile device 100 in the RF field of the reader 110 of POS terminal 120, as discussed in further detail below.

At this stage, the wallet application deactivates the CRS applet and displays messages on the GUI display with wording such as: “Payment Info Read, see terminal for more information”, and “Loyalty Points Earned”.

At step 230, once the payment transaction has been completed (i.e. approved or declined), the payment service provider 160 formats and sends a transaction verification message to the POS terminal 120 which, in turn finalizes the transaction and returns an acknowledgement to the payment service provider 160. Finally, if the transaction is approved and is subject to loyalty reward, the POS terminal 120 sends a command to loyalty CRM system 170 for crediting the consumer's loyalty point balance. Otherwise, if the transaction is timed out, the wallet application deactivates the CRS and displays an appropriate message such as: “Transaction Did Not Complete”.

In parallel, the POS terminal 120 continues its process in a well-known manner. If points have been redeemed, the receipt shows the redemption points used, redemption dollar amount, and the reduced transaction amount.

If the payment transaction is declined for any reason, the consumer is presented with an option to select another method of payment (cash, credit or debit) without using the wallet application and mobile device 100, in order to pay for the remainder of the transaction balance. If the consumer does not have another method of payment, he/she can be provided with a refund of the redeemed loyalty points in the form of a gift card or other form of loyalty credit.

Turning to FIG. 5, a flow chart is provided depicting details of the user interface startup sequence 200 of the method illustrated in FIG. 2. Upon selecting the desired payment and loyalty cards to be used for a transaction, the wallet application sends a web service call to loyalty CRM system 170 requesting the consumer's available points balance in response to which the loyalty CRM system 170 responds with the requested point balance (step 500). According to an embodiment, the wallet application then causes mobile device 100 to display the available points as illustrated in FIG. 4, along with a prompt to tap the GUI display for points redemption (step 510).

Upon selecting the desired points to redeem, the wallet application sends a command for setting the redemption points into the SE secure storage area associated with the selected loyalty card (step 520).

In response to the consumer pressing the “Pay Now” button (see FIG. 4), the wallet application activates a payment applet and loyalty applet in the UICC SE (step 530).

Turning to FIG. 6, a flow chart is provided depicting details of the loyalty transaction sequence 210 of the method illustrated in FIG. 2. Once the merchant cashier has selected an amount for the transaction and the type of payment (or the consumer passes merchandise under the bar code scanner laser beam of a self-serve checkout terminal, as discussed above), the consumer positions mobile device 100 within the RF field of the terminal reader 110 (step 600).

The terminal reader 110 initiates a loyalty transaction prior to the payment transaction by first sending a command to the loyalty applet in the SE using an application identifier (AID) (step 610). If the AID is not found, terminal reader 110 sends a command to the payment applet in the SE using a payment applet AID (selected via Proximity Payment Systems Environment (PPSE)) and performs a standard contactless payment transaction using, for example, a payment transaction flow that is the same as a standard PayWave®/PayPass® contactless card transaction.

If the loyalty applet is successfully selected, at step 620 the terminal reader 110 sends a command for retrieving the loyalty ID field and redemption points (Loyalty Proprietary Field) from the SE. Based on the input parameters, the loyalty applet matches the stored loyalty ID within the SE, and responds with the loyalty ID and user pre-set redemption points (Loyalty Proprietary Field).

Once read, the terminal reader 110 sends an update loyalty transaction command to the SE to allow the wallet application to determine if the points have been read by the terminal reader 110 (step 630).

The POS terminal 120 then sends a web service call with the loyalty ID and the requested points to the loyalty CRM system 170 for authorization (step 640).

The loyalty CRM system 170 then verifies the loyalty ID and authorizes the requested redemption points. If authorized, the loyalty CRM system 170 responds with response data indicating one of either success, error code, and MaxPointAllowed (same as points requested if success, if not enough, then max points allowed).

The POS terminal 120 then adjusts the final transaction amount by the available points for redemption (step 650).

Otherwise, if the authorization fails, due to a decline/critical error/timeout, the POS terminal 120 aborts the loyalty transaction, and does not adjust transaction amount, in which case the full transaction amount is charged to the selected payment credential. An error message can also be shown on the cashier's or self-serve checkout terminal screen.

Finally, the wallet application resets the default position for loyalty credentials/cards in the carousel (FIG. 3).

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A system for point-of-sale processing of a loyalty transaction within a standard financial transaction through a contactless interface, comprising:
a mobile device having a wallet application configured to store a customer's loyalty and payment accounts;
a point-of-sale terminal configured for contactless communication with the mobile device;
a loyalty CRM system for receiving a request for administering consumer loyalty point balances;
wherein responsive to a payment and loyalty point redemption command input to said wallet application, said wallet application initiates a loyalty point balance transaction between the mobile device and loyalty CRM system in response to which the wallet application stores the available points in the mobile device; and
wherein responsive to the mobile device being positioned within an RF field of the point-of-sale terminal the wallet application initiates a staged transaction whereby the point-of-sale terminal adjusts a final transaction amount by the available points for redemption.

2. A system as in claim 1, further comprising a payment service provider for processing payment of said final transaction amount, and in return provides an electronic receipt to the mobile device.

3. A method for point-of-sale processing of a loyalty transaction within a standard financial transaction through a contactless interface, comprising:
storing a customer's loyalty and payment accounts in a wallet application on a mobile device;
responsive to a payment and loyalty point redemption command input to said wallet application, initiating a loyalty point balance transaction between the mobile device and a loyalty CRM system in response to which the wallet application stores the available points in the mobile device; and
wherein responsive to the mobile device being positioned within an RF field of a point-of-sale terminal initiating a staged transaction whereby the point-of-sale terminal adjusts a final transaction amount by the available points for redemption.

4. In a system for point-of-sale processing of a loyalty transaction within a standard financial transaction through a contactless interface, the system including a mobile device having a wallet application configured to store a customer's loyalty and payment accounts, a point-of-sale terminal configured for contactless (near field communication or NFC) communication with the mobile device, a payment service provider, and a loyalty CRM system for receiving a request for administering consumer loyalty point balances, a method comprising:
storing a customer's loyalty and payment accounts in the wallet application;
responsive to a payment and loyalty point redemption command input to said wallet application, initiating a loyalty point balance transaction between the mobile device and loyalty CRM system in response to which the wallet application stores the available points in the mobile device; and
responsive to the mobile device being positioned within an RF field of the point-of-sale terminal initiating a staged transaction whereby the point-of-sale terminal adjusts a final transaction amount by the available points for redemption.

5. The method of claim 4, further comprising selecting a loyalty account and payment account using a graphical user interface (GUI) of said wallet application.

6. The method of claim 5, wherein upon completion of the loyalty point balance transaction, the point-of-sale terminal sends a command to a payment applet in a secure element of the mobile device and performs a contactless payment transaction with the adjusted final transaction amount.

7. The method of claim 6, wherein a issuer host generates a payment transaction authorization request responsive to the mobile device being positioned within the RF field of the point-of-sale terminal.

8. The method of claim 7, wherein the wallet application displays at least one message on the graphical user interface (GUI) indicating that payment information has been read and loyalty points earned.

9. The method of claim 8, wherein upon completion of the payment transaction the payment service provider formats and sends a transaction verification message to the point-of-sale terminal which in response finalizes the transaction and returns an acknowledgement to the payment service provider.

10. The method of claim 9, wherein the point-of-sale terminal sends a command to loyalty CRM system for crediting the loyalty point balance.

11. The method of claim 5, wherein the wallet application sends a web service call to the loyalty CRM system requesting the loyalty point balance in response to which the loyalty CRM system responds with the requested point balance.

12. The method of claim 11, wherein the wallet application causes the mobile device to display the available points balance along with a prompt to tap the graphical user interface (GUI) for points redemption.

13. The method of claim 12, wherein responsive to selecting points for redemption, the wallet application sends a command for setting the redemption points in a secure storage area of the mobile device associated with the selected loyalty card.

14. The method of claim 13, wherein responsive to selecting payment via the graphical user interface (GUI) the wallet application activates a payment applet and loyalty applet in the secure storage area of the mobile device.

15. The method of claim 14, wherein the point-of-sale terminal initiates a loyalty transaction prior to the payment transaction by first sending a command to the loyalty applet in the secure storage area using an application identifier (AID) in response to selecting the loyalty applet and then sending a command for retrieving a loyalty ID field and redemption points from the secure storage area.

16. The method of claim 15, wherein the loyalty applet matches the stored loyalty ID within the secure storage area based on the input parameters, and responds with the loyalty ID and selected redemption points.

17. The method of claim 16, wherein the point-of-sale terminal sends an update loyalty transaction command to the secure storage area to allow the wallet application to determine if selected redemption points have been read by the point-of-sale terminal.

18. The method of claim 17, wherein the point-of-sale terminal sends a web service call with the loyalty ID and the selected redemption points to the loyalty CRM system for authorization.

19. The method of claim 18, wherein the loyalty CRM system verifies the loyalty ID and authorizes the selected redemption points.

20. The method of claim 19, wherein the loyalty CRM system transmits response data indicating one of either success, an error code, and a message indicating the maximum redemption points available.

21. The method of claim 20, wherein the point-of-sale terminal adjusts the final transaction amount by the available points for redemption.

22. The method of claim 20, wherein if the authorization fails the point-of-sale terminal aborts the loyalty transaction and does not adjust the final transaction amount, in response to which the final transaction amount is charged to the selected payment account.
